(19) United States
(12) Patent Application Publication
(10) Pub. No.: US 2013/0339431 A1
(43) Pub. Date: Dec. 19, 2013

(54) Replay of Content in Web Conferencing Environments

(71) Applicants: Konstas Yannakopoulos, Bolton, MA (US); John Russell, Shirley, MA (US); Brian Glanville, Shirley, MA (US); Dhiren Patel, Berlin, MA (US); David Putterman, Cambridge, MA (US)

(72) Inventors: Konstas Yannakopoulos, Bolton, MA (US); John Russell, Shirley, MA (US); Brian Glanville, Shirley, MA (US); Dhiren Patel, Berlin, MA (US); David Putterman, Cambridge, MA (US)

(73) Assignee: CISCO TECHNOLOGY, INC., San Jose, CA (US)

(21) Appl. No.: 13/495,445

(22) Filed: Jun. 13, 2012

(51) Int. Cl. G06F 15/16

(52) U.S. Cl. 709/204

(57) ABSTRACT

A method, an apparatus and computer readable storage media facilitate engaging in a web conference session between computing devices over a network, where the web conference session includes audio and video content communicated from at least one computing device to at least one other computing device during the web conference session. A first computing device engages in the web conference session at a first time that is after a start time of the web conference session and while the web conference session is ongoing, and the first computing device displays a time shifted portion of the web conference session prior to the first time and while the web conference session is ongoing.

### TECHNICAL FIELD

The present disclosure relates to web conferencing environments including audio and video communications as well as other exchanges of content between participants within such web conferencing environments.

### BACKGROUND

Web conferencing platforms exist in many different commercial, business and social settings to facilitate communications between participants at different computing devices, including web conferencing communications in which participants at different computing devices can communicate in real-time via audio and video content being exchanged between the participants. Different types of web conferencing platforms are known and currently utilized in both personal and business environments. Web conferencing is becoming particularly useful in business scenarios to facilitate live, online audio and video meetings in real-time between participants that are located at different geographic locations.

One issue that may occur during a web conference meeting is that a participant may need to time shift within the meeting (e.g., rewind or fast forward to a time period within the meeting other than current, live or real-time). For example, a participant may wish to replay a portion of the meeting that the participant missed or did not understand. However, the participant may also wish to continue recording the current, ongoing meeting while replaying portions of the meeting that participant wishes to revisit. For example, there may be scenarios in which a speaker within the meeting states an important piece of information that a participant wishes to replay. Other issues are that a participant may join a meeting late or need to disconnect from the meeting for a short period but then return and revisit portions of the meeting the participant missed. Further, if the audio and/or video portions of the meeting are dropped for some reason for a participant (e.g., due to the disruptions in the data stream being provided to the participant's computing device), the participant may wish to revisit portions of the meeting content that were missed. Typical web conferencing platforms do not provide the flexibility or software tools or features for handling such scenarios.

### BRIEF DESCRIPTION OF THE DRAWINGS

FIG. 1 is a schematic block diagram of an example system in which computing devices are connected to facilitate operation within a collaboration platform that includes web conferencing tools to facilitate communications between computing devices within the platform.

FIG. 2 is a schematic block diagram of an example computing device connected with a server that facilitates operations of an enterprise social software platform within the system of FIG. 1.

FIG. 3 is a schematic block diagram of an enterprise collaboration application module utilized for the computing device depicted in FIG. 2.

FIG. 4 depicts an embodiment of an example graphical user interface (GUI) for use with a computing device to facilitate control of operations within a web conference session in which the computing device is engaged in the system of FIG. 1.

FIG. 5 is a flow chart depicting an example process for engaging in a web conference session between computing devices within the system of FIG. 1, including participant viewing of time shifted content within the ongoing web conference session.

FIG. 6 is an example display window associated with time shifting to replay recorded content during an ongoing web conference session utilizing the system of FIG. 1.

FIG. 7 is an example embodiment of a player window associated with the GUI of FIG. 4.

### DESCRIPTION OF EXAMPLE EMBODIMENTS

### Overview

A method, an apparatus and computer readable storage media facilitate engaging in a web conference session between computing devices over a network, where the web conference session includes audio and video content communicated from at least one computing device to at least one other computing device during the web conference session. A first computing device engages in the web conference session at a first time that is after a start time of the web conference session and while the web conference session is ongoing, and the first computing device displays a time shifted portion of the web conference session prior to the first time and while the web conference session is ongoing.

### Example Embodiments

Collaboration platform systems that facilitate web conferencing sessions between participants at computing devices connected within the platform are described herein. The web conferencing sessions that are facilitated by the systems provide a number of useful features that allow participants to conduct a number of different time shifting operations while being engaged within an ongoing web conference session. A web conference session refers to a communication between at least two participants within the system in which content is exchanged between participants or transmitted by at least one participant to one or more other participants via the computing devices of the participants. The content can comprise audio content, video content, as well as any other types of content including, without limitation, captured screen images of a participant's computing device that is desired to be shared as content for the web conference session including one or more open documents (e.g., text documents, images, slides, spreadsheets, etc.). The audio, video and/or other content is transmitted in a digital format within one or more data streams from at least one computing device to other computing devices engaged in the ongoing web conferencing session. The term time shifting, as used herein, refers to presenting (displaying or viewing) audio, video and/or other content at a computing device that has been recorded within the ongoing web conference session and is at a point in time that is prior to a present or current time in which the ongoing web conference session is occurring (i.e., time shifting to a point in time in the past in relation to the ongoing web conference session that is occurring in real time).

The collaboration platform systems can facilitate other communication functions in addition to web conferencing including, without limitation, emailing, calendaring and scheduling, instant messaging, posting of content in the form of blogs, wikis or any other types of content, etc. The systems can include any suitable application modules including software applications that provide different types of communication tools and features for such communication tools. The term “tool”, as used herein, refers to an “application” software function or set of functions provided by a software application on a computing device and/or hosted on a server on behalf of a computing device. Application modules refer to a set of one or more software applications that provide the software tools used by the computing devices and/or servers.

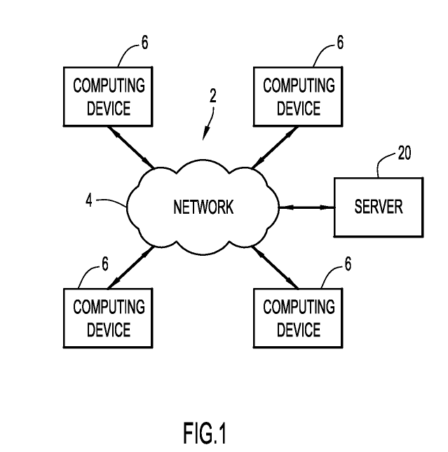

Referring to FIG. 1, a block diagram is shown for an example system that supports operation of a collaboration platform facilitating communications including web conferencing or web conference sessions between computing devices. The computing devices are connected via one or more host servers that facilitate communications and exchange of information between the computing devices. In particular, the system 2 comprises a network 4 that facilitates communications and exchange of information between a plurality of computing devices 6 as well as one or more platform servers 20. Examples of types of networks that can be utilized within system 2 to facilitate web conference sessions as well as other types of communication sessions include, without limitation, any one or more of local or wide area networks, Internet Protocol (IP) networks such as intranet or internet networks, telephone networks (e.g., public switched telephone networks), wireless or mobile phone or cellular networks, and any suitable combinations thereof. While only four computing devices 6 are depicted within FIG. 1, this is for example purposes only and it is noted that any number of computing devices may connect with and engage in communications such as web conference sessions within the system platform (e.g., hundreds, thousands or more computing devices).

The system 2 also includes at least one host server 20 to host the operations of the platform so as to facilitate platform operations including communications such as web conference sessions between the computing devices 6. While a single platform server 20 is depicted in FIG. 1, it is noted that the system 2 can include any number of servers to host and support operations and functions of the platform in a suitable manner and depending upon the number of computing devices/participants within the platform. Alternatively, it is noted that the platform can also be supported in any other suitable manner, in which one or more computing devices are configured to facilitate a suitable connection with other computing devices over the network 4 to provide communications and exchange of information associated with the collaboration platform.

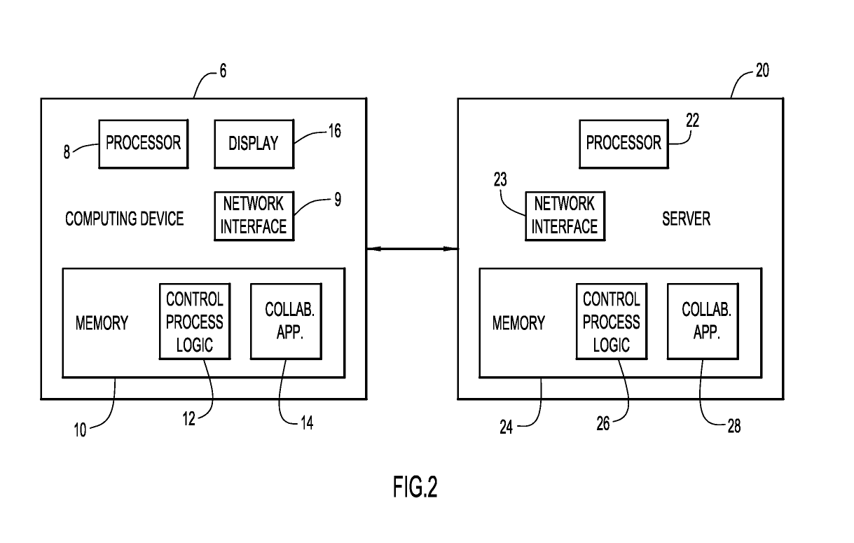

An example embodiment of a computing device that connects with a host server for the system 2 is depicted in FIG. 2. In particular, a computing device 6 connects with a host server 20 within system 2 to facilitate communications (including web conference sessions) and exchange of information with other computing devices 6 associated with users of the system platform. It is noted that FIG. 2 represents how each computing device 6 of the system of FIG. 1 can connect with a server 20. It is further noted that, while the embodiment of FIG. 2 depicts a single server 20, the system 2 can include multiple servers that support the collaboration platform within system 2. Each computing device 6 connects via any suitable wireless and/or hard wired connection to a server 20 to facilitate communications and exchange of information with other computing devices over the network. In particular, each computing device 6 includes a processor 8, a network interface 9, a memory 10, and a display 16. Similarly, the server 20 includes a processor 22, a network interface 23, and memory 24. The computing devices 6 and/or servers 20 can further include any other suitable devices integrated with the devices and/or any other types of peripheral devices that can be connected with the devices to facilitate input of audio, video or other information by a user to the computing device (e.g., keyboards, mouse devices, cameras, microphones, etc.) as well as presentation (output or display) of audio, video and/or other types of information to the user by the computing device.

The network interfaces 9 and 23 of the computing devices 6 and servers 20 can be, for example, one or more of an Ethernet interface card or switch, a modem, a router or any other suitable hardware device that facilitates a wireless and/or hardwire connection over the network 4 with one or more servers 20 and other computing devices 6, where the network interface unit can be integrated within the device or a peripheral that connects with the device.

Each of the processors 8, 22 can comprise a microprocessor that executes control process logic instructions 12, 26 stored within memory 10, 24, including operational instructions and software applications stored within such memory (e.g., applications associated with web conferencing and other types of communications and sharing of information via the collaboration platform).

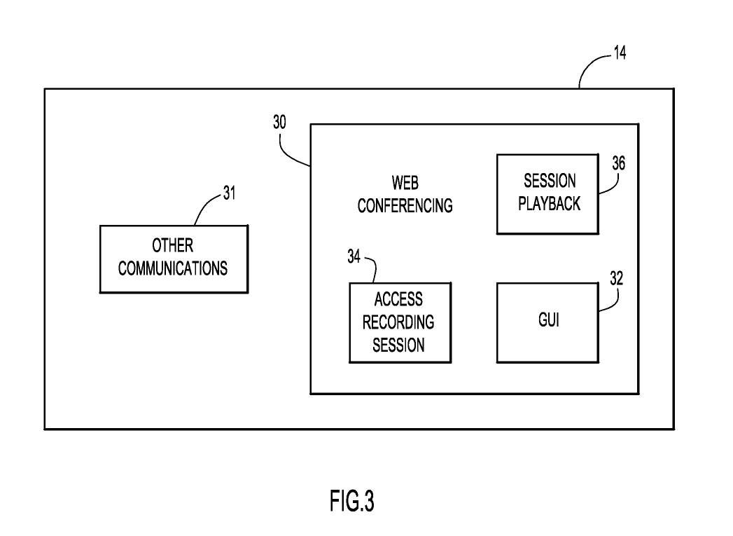

For example, the memory 10 of each computing device 6 includes a collaboration application module 14 that comprises one or more software applications, such as those depicted in FIG. 3, that provide software tools to facilitate connection of the computing device 6 to the collaboration platform within system 2, via one or more servers 20, and also engage in the various activities associated with the enterprise collaboration platform. The software tools provided by the collaboration application module 14 include a web conferencing module 30 that facilitates engaging in a web conference session with other computing devices via the collaboration platform depicted by system 2 in FIG. 1. The software tools of the collaboration application module 14 further includes one or more other software modules (depicted generally as Other Communications module 32 in FIG. 3) that facilitate other types of communications (e.g., email, instant messaging, the posting of content via blogs, wikis, and/or other mechanisms, etc.) between a computing device 6 and other computing devices 6 over the network and within the collaboration platform of the system 2. Collaboration platforms that provide one or more different types of communication services, including web conferencing services, to computing devices are known (e.g., Cisco WebEx, Cisco Quad, Microsoft Office Live Meeting, GoToMeeting by Citrix Online, IBM LotusLive, etc.).

The web conferencing module 30 includes one or more applications the facilitate operations by the computing device 6 while engaging in a web conference session, including initiating or joining a web conference session, facilitating the exchange of audio and/or video content between the computing device 6 and other computing devices during the web conference session, and providing interactive features for a participant operating the computing device 6 while engaging within the web conference session. For example, the web conferencing module 30 can include a graphical user interface (GUI) application module 32 including one or more applications that provide a GUI for a participant that is displayed at the computing device 6 and includes interactive features to allow the participant to perform certain features while within a web conferencing session. The module 30 can further include an access recording session module 34 that includes one or more applications which obtain access to audio and video content of the web conference session that is being recorded (e.g., by one or more host servers 20). In addition, the module 30 can include a session playback module 36 including one or more applications that facilitate time shifting within an ongoing or real-time web conference session by the participant as described herein. The collaboration application module 28 of each server 20 associated with the collaboration platform within the system 2 can include similar modules that facilitate performance of operations for establishing web conference sessions between computing devices 6.

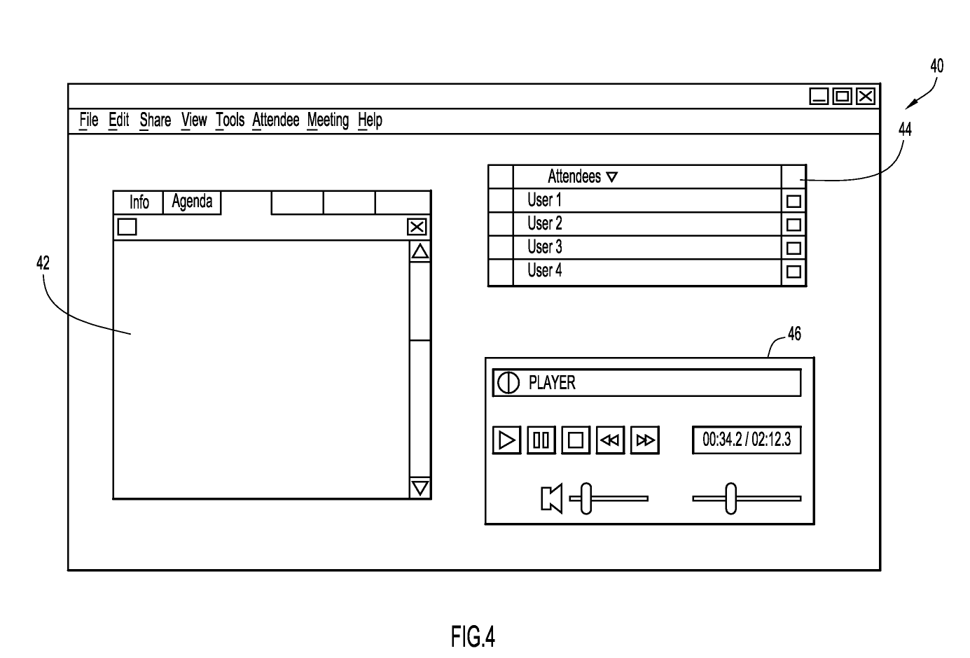

The processors 8 and 22 of the computing devices 6 and servers 20 perform operations in accordance with the steps set forth in the flow chart of FIG. 4 utilizing the software application tools of the collaboration application modules 14, 28, as described further below.

The memories 10 and 24 of the computing devices 6 and servers 20, respectively, may comprise read only memory (ROM), random access memory (RAM), magnetic disk storage media devices, optical storage media devices, flash memory devices, electrical, optical, or other physical/tangible (e.g., non-transitory) memory storage devices, and any combinations thereof. The display 16 of each computing device can be an LCD or any other suitable type of display, including touch pad displays (e.g., for tablets, smart phones, or other portable types of computing devices) for display of textual and/or graphical content by the processor 8 of the computing device 6, including audio, video, textual, interactive and/or any other forms of content which may be operated and controlled by a participant via the one or more GUI applications 38.

Some examples of computing devices 6 that can be used to engage and participate in web conference sessions as well as other communications and activities within a collaboration platform within system 2 include, without limitation, stationary (e.g., desktop) computers, personal mobile computer devices such as laptops, note pads, tablets, personal data assistant (PDA) devices, and other portable media player devices, and cell phones (e.g., smartphones) including suitable input and output devices as described above. The computing devices and servers can utilize any suitable operating systems (e.g., Android, Windows, Mac OS, Symbian OS, RIM Blackberry OS, Linux, etc.) to facilitate interaction, activities, exchange of audio and video content for web conference sessions as well as sharing of other types of information between computing devices via the collaboration platform.

Suitable servers 20 can be any suitable types of stationary or other types of computing devices capable of hosting and managing web conferencing sessions as well as other communications and activities of the collaboration platform (e.g., simultaneously managing a plurality of web conference and/or other types of communication sessions as well as large flows of data associated with the collaboration platform). Each server 20 can be configured to provide the function of handling and transferring audio and video content for web conference sessions as well as other types of content (e.g., via data bit streams) between two or more computing devices 6 over the network 4 utilizing the modules 28 of the servers 20. Each server 20 can also be provided with suitable memory capacity to store content associated with web conference sessions (e.g., storing recorded audio and video content for one or more web conference sessions) as well as other communications for each customer device 6. In addition, the collaboration application modules 28 of each server 20 can have suitable software tools that facilitate the hosting of synchronous communications between the computing devices 6 as well as multiple simultaneous group communications (e.g., the simultaneous hosting of a web conference session between a first group of computing devices and a hosting of another web conference session or other form of communication between a second group of computing devices).

Thus, the configurations of computing devices 6 and one or more servers 20 as described herein facilitate the engagement in web conference sessions and, optionally, other forms of communication between the computing devices that are connected in the manner described herein and as depicted in FIGS. 1-3. In an example embodiment, each computing device 6 is associated with a participant who has a registered account within the collaboration platform which identifies the participant to other participants (e.g., so as to identify participants who log into or engage with a web conference session being hosted within the collaboration platform).

An example embodiment of an interactive GUI for display at a computing device 6 and that is rendered operable via collaboration application modules 14 and 28 to facilitate operations within a web conference session by a participant is depicted in FIG. 4. A GUI 40 allows a participant at a computing device 6 to launch and engage in a web conference session. The GUI 40 includes a number of tabs to show features in different windows as well as a number of pull down menus that are selectable (e.g., via hovering over and clicking with a mouse pointer or other navigable icon that is used by the participant to interact with the GUI) to allow the participant to select different operational features within the GUI. The many different features that can be provided in an interactive GUI for a web conference session (e.g., a Cisco WebEx session) are already known and are not described in detail herein. Generally, the GUI 40 allows a participant to view video and/or other types of content (e.g., within display window 42) and control features (e.g., volume) of audio content associated with a web conference session. The GUI 40 also can be configured to display (e.g., within window 44) a list of participants that are current joined or logged into the ongoing web conference.

A player window 46 can also be provided by the GUI 40 that allows a participant to control a number of features associated with the web conference session. For example, player window facilitates a volume adjustment or control for the sound level of audio content associated with the web conference session. The GUI 40 also permits the participant to record any selected portion or portions (e.g., some or all) of any given web conference session, and the player window 46 provides a participant with the ability to replay any portion of the recorded web conference session after the web conference session has ended. The features of recording a web conference session for playback after the web conference session has ended are known and described, e.g., in U.S. Pat. Nos. 7,213,051 and 7,945,621, the disclosures of which are incorporated herein by reference in their entireties. However, in accordance with the embodiments described herein, the player window 46 can further be used to allow a participant to time shift while within an ongoing web conference session. This allows a number of features that have not heretofore been utilized within a web conference session, namely, the ability to time shift or go back to a previous portion of the web conference session while it is ongoing in order to replay an important part that the participant may have missed or may need to view again. In addition, as described herein, the time shifting features allow the participant to reply audio and/or video content from the past (and during the ongoing web conference session) at a faster speed so as to allow the participant to “catch up” to or converge with the ongoing web conference session in real time so as to not miss any of the ongoing session.

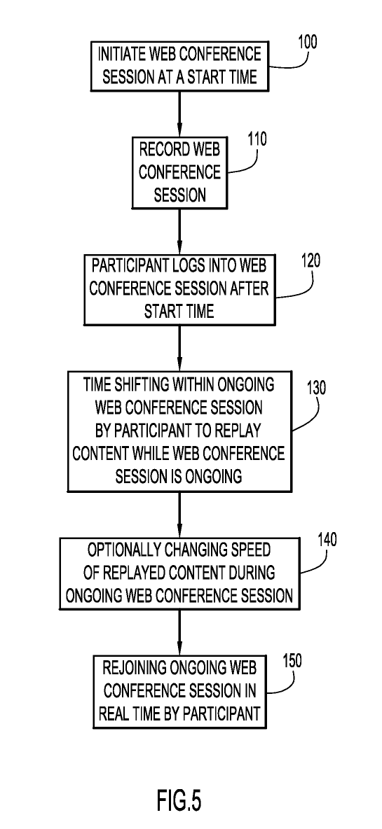

Operation of the system 2 in relation to hosting a web conferencing session and facilitating time shifting within the ongoing web conferencing session is now described with reference to the flow chart of FIG. 5. At 100, a web conference session is initiated between computing devices 6, utilizing the collaboration application modules 14 and 28 of the devices and one or more servers 20 that host the web conference session. During the web conference session, audio and video content associated with the web conference session (e.g., captured audio and video content from a participant at one of the computing devices 6 that is logged into the web conference session) is communicated to the participants who have joined the session via their computing devices, where the content can be hosted by one or more servers 20 (e.g., computing devices 6 logged into the web conference session obtain audio and video content within data streams from one or more host servers 20). At 110, the content of the ongoing web conference session is recorded (e.g., by the one or more host servers 20 assigned to host the session). This recorded content can be accessed by any of the computing devices 6 via the GUI 40 of each computing device (e.g., utilizing the player window 46).

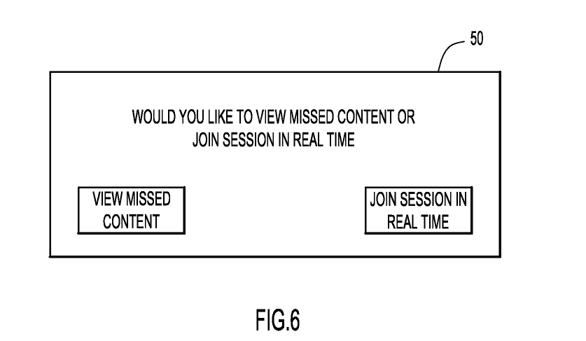

At 120, a participant logs into the web conference session after the start time. The participant can either join the web conference session at the current point in time (i.e., in real time) that the participant has joined the web conference session or, alternatively, time shift to a period in time in the past in which the participant has missed portions of the web content. For example, when logging into the web conference after the start time, a pop-up window may appear such as the window 50 depicted in FIG. 6. If the participant chooses to join the session in real time, the participant's computing device 6 receives audio and video content that corresponds with the live, ongoing session (i.e., at the current or real time).

At 130, in response to the participant choosing to view missed content, the participant time shifts within the ongoing web conference session to replay recorded audio and video content of the session while the session is ongoing. In particular, the participant's computing device 6 (e.g., utilizing the access recording session module 34), accesses recorded content (e.g., stored by one or more host servers 20) and plays such recorded content (utilizing the session playback module 36 and player window 46) within the window 42 of GUI 40.

The time shifted viewing of recorded content of the web conference session (e.g., replaying content from the session at a past point in time) by the participant while the session is ongoing can occur at any selected point in time from the start time to the current time of the ongoing session. For example, in a scenario in which the participant has first logged into the web conference session at some point after the start time, the participant can begin viewing or replaying the recorded content at the beginning or start time of the session. Alternatively, in a scenario in which the participant logged into the web conference session at the start time (or at some other prior point in time) but then logged off the session at an intermediate point in time (i.e., a time after the initial log in time for the participant), the participant may only need to replay the recorded content at the intermediate point in time (since the participant may have already viewed the previous content for the session prior to logging off at the intermediate point in time).

The system 2 can be configured to automatically determine the point in time at which content from the web conference session was not viewed by the participant and therefore might be replayed by the participant. For example, in the scenario in which the participant is first logging into the session after the start time, a host server 20 can recognize (utilizing its collaboration application module 28 and the recognition of all participants attending the web conference session at any given time) that the participant has not viewed any content for the session prior to the current point in time and thus set a time shifted point for the participant to view recorded content as the start time of the web conference session.

In another scenario in which the participant had logged into the web conference session at a prior point in time but then logged off (e.g., the participant may have inadvertently lost a connection within the platform and thus was dropped from the session, or the participant may have actively dropped off the session), the status of the participant (as well as other participants) within the session can be monitored (e.g., by the host server(s) 20 associated with the web conference session) so as to flag or mark and store (e.g., at the host server(s) 20) the point in time or time stamp at which the participant logged off from the session. When the participant logs back into the ongoing web conference session, the missed content to be viewed by the participant can begin by time shifting to replaying recorded content at the flagged or time stamped point in time at which the participant logged off from the session.

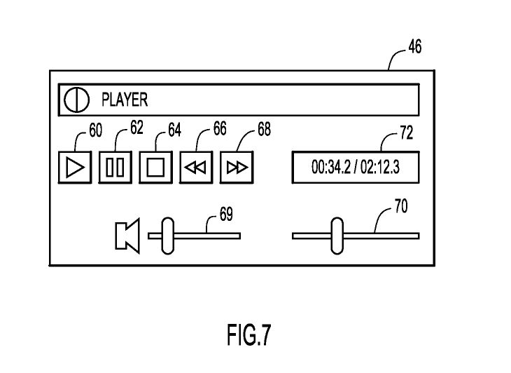

At 140, the participant can change the replay speed of the recorded content, while the session is still ongoing, in order to catch up or converge with the ongoing session prior to the end of the session. Referring to FIG. 7, the player window 46 shows a number of interactive input buttons 60-70 that are selectively actuated by the participant (e.g., via a mouse pointer or other icon which interacts with the GUI 40) to facilitate control by the user of audio and video content of the web conference session while the session is ongoing. Input buttons 62, 64, 66 and 68 respectfully allow the participant to control playing, pausing, stopping, rewinding, and fast forwarding of the recorded content. Input button 69 is provided in a sliding configuration to control the volume of the audio portion of the content. The rewind and fast forward buttons 66 and 68 allow for replay of recorded content at one or more different speeds (e.g., speeds of 2×, 3×, 4×, etc. of the normal speed at which the content is recorded, where current speed is designated as 1×) by selecting the buttons (e.g., clicking on button 68 by the mouse pointer by the participant multiple times can adjust the fast forwarding speed at which recorded content is replayed by the computing device 60). The participant can watch a replay of recorded content (e.g., to view what the participant has missed) at a faster speed (e.g., at 2×, 3× or 4× speed) than the normal speed at which content from the web conference session is recorded (e.g., 1×). At certain faster speeds, the participant can still comprehend the content while at the same time catching up or closing the time gap between the shifted point in time at which the participant started to view recorded content and the current or real (i.e., live) time at which the ongoing session is progressing. Thus, the participant can view any missed content prior to joining the ongoing session in real time.

At 150, the participant rejoins the ongoing web conference session in real time. This can happen by the participant catching up with the current time at which the web conference session is recorded. Alternatively, the participant can jump at any given time to the current audio and video content for the ongoing web conference session. Input button 70 allows the participant to jump to the current point in time within the ongoing collaboration session (e.g., by sliding the button 70 toward the right side of the player window 46 as depicted in FIG. 7). Window 72 provides an indication of the location at which recorded content is being replayed in relation to the current time of the ongoing web conference session (e.g., window 72 indicates that the participant is replaying recorded content at 34 minutes, 2 seconds of the session, while the ongoing session is currently at 2 hours, 12 minutes, 3 seconds).

Thus, the embodiments described herein facilitate time shifting by a participant within an ongoing web conference session by replaying recorded content from the session while the session is still ongoing. Replaying of recorded content can be triggered or provided as an option for a participant that has joined (or rejoined) a web conference session after the start time of the session.

Any participant can also, at any given time within the ongoing web conference session and utilizing the features of the player window 46 within the GUI 40, time shift to any given previous point in time within the ongoing session so as to replay recorded content at the selected previous point in time. In particular, the sliding button 70 of the player window 46 of the GUI 40 allows a participant to time shift at any time within the ongoing web conference session so as to replay recorded content. The rewind button 66 also allows the participant to time shift backward to any point in time for the recorded content of the ongoing session. For example, a participant may wish to replay a previous portion that was important and that the participant may not have clearly understood or that was not clear (e.g., the data stream to the participant's computing device 6 was corrupt or included artifacts or other defects, whereas the recorded content is free of such defects).

In addition, the system 2 can include (e.g., at the host server or servers 20) a transcription feature that transcribes all audio content of a web conferencing session into text in substantial real time and as the web conference session is ongoing. The text that is obtained from the transcription of the ongoing web conference session can be searched by a participant who may have missed portions of the ongoing web conference or who desires to replay content of greater importance to the participant. The transcribed text can be time stamped to correspond with the recorded audio and video content. For example, the participant can search, during the ongoing web conference session, for a particular word or phrase that may have been used within the session. While the session is ongoing, the participant can time shift so as to replay recorded content that corresponds with a word or phrase that was found from a search by the participant. A search feature can be implemented, e.g., as part of the GUI 40 for the participant.

The above description is intended by way of example only.

What is claimed is:

1. A method comprising:
during a web conference session between computing devices over a network, wherein the web conference session comprises content communicated from at least one computing device to at least one other computing device during the web conference session, engaging in the web conference session by a first computing device at a first time that is after a start time of the web conference session and while the web conference session is ongoing; and
displaying a time shifted portion of the web conference session by the first computing device prior to the first time and while the web conference session is ongoing.

2. The method of claim 1, wherein the engaging in the web conference session by the first computing device further comprises:
engaging in the web conference session by the first computing device at a second time that is prior to the first time; and
disengaging from the web conference session by the first computing device at a third time that is prior to the first time and after the second time.

3. The method of claim 2, wherein the displaying of the time shifted portion of the web conference session by the first computing device further comprises:
displaying the time shifted portion of the web conference session starting at the third time when the first computing device engages in the web conference session at the first time.

4. The method of claim 3, further comprising:
recording, at a second computing device, content associated with the web conference session from at least a period beginning at the third time; and
accessing recorded content from the second computing device by the first computing device associated with the web conference session during at least a period of time between the third and first times.

5. The method of claim 1, further comprising:
recording, at a second computing device, content associated with the ongoing web conference session and beginning at the start time;
time stamping a time period prior to the first time by the second computing device and based upon a determination by the second computing device that the first computing device is not engaged with the web conference session; and
accessing recorded content associated with the web conference session from the second computing device by the first computing device starting at the time stamped time period that is prior to the first time.

6. The method of claim 1, further comprising:
displaying content associated with the web conference session at the first computing device and starting prior to the first time at a faster incremental forward chronological speed than a chronological speed at which the web conference session is occurring in real time so as to facilitate advancement of the content being displayed at the first computing device and eventual convergence of the displayed content with the ongoing web conference session in real time.

7. The method of claim 1, wherein the content of the web conference session comprises at least one of audio, video and captured screen images being shared by a computing device for a participant of the web conference session.

8. An apparatus comprising:
a memory configured to store instructions including one or more web conferencing applications;
a display device configure to display content; and
a processor configured to execute and control operations of the communication application so as to:
engage the apparatus in a web conference session at a first time that is after a start time of the web conference session and while the web conference session is ongoing, wherein the web conference session comprises content communicated from at least one computing device to other computing devices including the apparatus; and
facilitate display of a time shifted portion of the web conference session, via the display device, prior to the first time and while the web conference session is ongoing.

9. The apparatus of claim 8, wherein the processor is further configured to:
engage the apparatus in the web conference session at a second time that is prior to the first time; and
disengage the apparatus from the web conference session at a third time that is prior to the first time and after the second time.

10. The apparatus of claim 9, wherein the processor is further configured to facilitate display of the time shifted portion of the web conference session, via the display device, starting at the third time when the apparatus engages in the web conference session at the first time.

11. The apparatus of claim 10, wherein the processor is further configured to:
access recorded content associated with the web conference session from a computing device during at least a period of time between the third and first times.

12. The apparatus of claim 9, wherein the processor is further configured to:
access recorded content associated with the web conference session from a computing device starting at a time stamped period that is prior to the first time, wherein the time stamped period is established by the computing device based upon a time period at which the apparatus is not engaged with the web conference session.

13. The apparatus of claim 9, wherein the processor is further configured to:
facilitate a display of content associated with the web conference session, via the display device, and starting prior to the first time at a faster incremental forward chronological speed than a chronological speed at which the web conference session is occurring in real time so as to facilitate advancement of the content being displayed by the display device and eventual convergence of the displayed content with the ongoing web conference session in real time.

14. The apparatus of claim 9, wherein the processor is further configured to facilitate a presentation of content of the web conference session, via the display device, comprising at least one of audio, video and captured screen images being shared by a computing device for a participant of the web conference session.

15. One or more computer readable storage media encoded with software comprising computer executable instructions and when the software is executed operable to:
during a web conference session between computing devices over a network, wherein the web conference session comprises content communicated from at least one computing device to at least one other computing device during the web conference session, engage in the web conference session with a first computing device at a first time that is after a start time of the web conference session and while the web conference session is ongoing; and
facilitate a display of a time shifted portion of the web conference session by the first computing device prior to the first time and while the web conference session is ongoing.

16. The computer readable storage media of claim 15, and further comprising instructions that are operable to:
engage in the web conference session with the first computing device at a second time that is prior to the first time; and
disengage from the web conference session with the first computing device at a third time that is prior to the first time and after the second time.

17. The computer readable storage media of claim 16, wherein the instructions are further operable to:
facilitate a display of the time shifted portion of the web conference session starting at the third time when the first computing device engages in the web conference session at the first time.

18. The computer readable storage media of claim 17, wherein the instructions are further operable to:
record, at a second computing device, content associated with the web conference session from at least a period beginning at the third time; and
facilitate access of recorded content from the second computing device by the first computing device associated with the web conference session during at least a period of time between the third and first times.

19. The computer readable storage media of claim 15, wherein the instructions are further operable to:
record, at a second computing device, content associated with the ongoing web conference session and beginning at the start time;
time stamp a time period prior to the first time by the second computing device and based upon a determination by the second computing device that the first computing device is not engaged with the web conference session; and
facilitate access of recorded content associated with the web conference session from the second computing device by the first computing device starting at the time stamped time period that is prior to the first time.

20. The computer readable storage media of claim 15, wherein the instructions are further operable to:
facilitate a display of content associated with the web conference session at the first computing device and starting prior to the first time at a faster incremental forward chronological speed than a chronological speed at which the web conference session is occurring in real time so as to facilitate advancement of the content being displayed at the first computing device and eventual convergence of the displayed content with the ongoing web conference session in real time.

21. The computer readable storage media of claim 15, wherein the instructions are operable to facilitate a presentation of content for the web conference session comprising at least one of audio, video and captured screen images being shared by a computing device for a participant of the web conference session.
